(19) United States
(12) Patent Application Publication
(10) Pub. No.: US 2016/0104166 A1
(43) Pub. Date: Apr. 14, 2016

(54) COMPUTERIZED ACCOUNT DATABASE ACCESS TOOL

(71) Applicant: MORGAN STANLEY, New York, NY (US)

(72) Inventors: MICHAEL COLE, Pittstown, NJ (US); PATRICK CHAN, New York, NY (US); KEVIN ENG, Flushing, NY (US); ADAM GENN, Manalapan, NJ (US); CHARLES MCMAHON, New York, NY (US); PATRICK SEDDEN, New York, NY (US); ANAND WAISHAMPAYAN, Bridgewater, NJ (US)

(73) Assignee: MORGAN STANLEY, New York, NY (NY)

(21) Appl. No.: 14/509,099

(22) Filed: Oct. 8, 2014

(51) Int. Cl. G06Q 30/00; G06Q 40/00

(52) U.S. Cl. CPC G06Q 30/018; G06Q 40/12

(57) ABSTRACT

A computerized method of identifying accounts stored in a database of an account management system, for review under jurisdictionally relevant CIP/AML/KYC requirements is described, as is a computerized account database access tool having a data extraction module, an inclusion rules module, an exclusion rules module and a merge and aggregate module.

### FIELD OF THE INVENTION

This disclosure relates generally to automated risk management and, more particularly, to computerized tools for use in complying with the Customer Identification Program (“CIP”), anti-money laundering (“AML”) and/or “Know Your Customer” (“KYC”) requirements.

### BACKGROUND

Identity theft, financial fraud, money laundering, terrorism financing, tax evasion and evading of international sanctions are global problems. As a result, many countries have instituted laws, rules and/or other legal controls as part of their legal and regulatory systems that require financial institutions and other regulated entities to prevent, detect, and report activities that may be indicative of the above when detected. These laws, rules and/or other legal controls are generally known as CIP, AML and/or KYC requirements (individually and collectively referred to herein as “CIP/AML/KYC requirements”).

Although banks and other financial institutions operating in the same country generally have to follow the same laws and regulations, many banks and financial institutions operate globally. Despite the formation of the Financial Action Task Force (FATF), whose membership now consists of about 36 countries and territories and two regional organizations, and its promulgation of uniform recommendations on money laundering and terrorist financing, the laws, rules and/or other legal controls implementing those recommendations vary from jurisdiction to jurisdiction, and the laws, rules and/or other legal controls are subject to varying interpretations when applied to specific circumstances. Moreover, the regulated entities involved with an individual account may themselves be or operate in multiple jurisdictions and thus be subject to the varied laws, rules and/or other legal controls in each of those multiple jurisdictions. A regulated entity that has a compliance problem in any jurisdiction risks fines, civil action, loss of the ability to operate in that jurisdiction, and even criminal prosecution.

Currently, entities subject to the above CIP/AML/KYC requirements promulgate policies based upon those requirements and will evaluate key data attributes and documentation for a new account when opened and, thereafter, may periodically check/audit existing accounts for entity-related or CIP/AML/KYC requirement-related changes necessitating re-review. Since account-level details are generally maintained in database(s) in some form of account management system, this is typically done by running reports, for example, using one or more SQL (or equivalent) queries on one or more account database(s) in an account management system, to identify those accounts that may need to be reviewed again or are to be audited. These reports or queries are structured to identify those entities that should be “in scope” for review under CIP/AML/KYC requirements.

However, the present report or query approach creates a technical problem because it leaves open the possibility of accounts being missed because, for example, there may be many types of entities who can have accounts (e.g. banks, charities, corporations, trusts, etc.), but the rules on which the quer(y/ies) are based may only specify a subset of those entities (without realizing that the rules are also applicable to other rarely used entities) so the quer(y/ies) may not take into account those types of entities. Likewise, it is a potential problem that the data itself maintained for the account, although proper and accurate, may not reliably coincide with the intent behind the rules, so queries closely conforming to the rules might be under-inclusive. Alternatively, the CIP/AML/KYC rules for a particular jurisdiction might be modified, but the query does not yet reflect or take into account the modification. The possibility of any such miss creates a technical problem that results in a real liability/compliance risk to the entity handling the missed account(s).

Thus, there is a present need for a tool and approach that reduces or eliminates the risk of missing an account for review, re-review, or for or during an audit.

### BRIEF SUMMARY

One aspect of this disclosure involves a computerized method of identifying accounts stored in a database of an account management system, for review under jurisdictionally relevant CIP/AML/KYC requirements. The method involves: retrieving, using a processor, specified data from all accounts in the database; for each account, using the retrieved specified data and the processor, determining whether each account is to be evaluated against regulatory requirements for at least one jurisdiction, out of multiple jurisdictions, by comparing retrieved data for each account with each of multiple jurisdiction-specific inclusion rules and, in each instance where an individual account satisfies a jurisdiction-specific inclusion rule, storing an identifier of that individual account in inclusion results storage specific to the jurisdiction associated with the satisfied jurisdiction-specific inclusion rule; applying exclusion rules associated with a specific jurisdiction to the retrieved data for each individual account whose identifier is stored in the inclusion storage for the specific jurisdiction and, in each instance where the retrieved data for the individual account satisfies one or more of the specific jurisdiction exclusion rules, storing that individual account's identifier in exclusion results storage along with data reflecting the jurisdiction and the one or more satisfied exclusion rules; and merging and aggregating all of the accounts, using contents of the inclusion results storage and exclusion data from the exclusion results storage, to (i) assign the accounts to per jurisdiction buckets for review under the relevant CIP/AML/KYC requirements of the respective jurisdictions; and (ii) maintain Scope/Reason buckets reflecting, for each account, each inclusion rule that caused them to have specific jurisdictional associations and each exclusion rule that caused any of the accounts to be excluded from review under any jurisdiction's CIP/AML/KYC requirements.

Another aspect involves a computerized account database access tool. The tool is made up of: a data extraction module, running on at least one processor, configured to receive specified data from all accounts in a database and store the received specified data in non-transient storage; an inclusion rules module, running on the at least one processor, configured to analyze the stored specified data in accordance with jurisdictional inclusion rules and assign accounts that satisfy at least one inclusion rule for a jurisdiction to inclusion results storage in a group for that jurisdiction; an exclusion rules module, running on the at least one processor, configured to analyze, on a jurisdiction basis, the accounts assigned to jurisdictional groups in the inclusion results storage and store analysis results in exclusion results storage; and a merge and aggregate module, running on the at least one processor, configured to merge and aggregate the accounts stored in the inclusion results storage with the analysis results in the exclusion results storage in order to (i) assign accounts that satisfy jurisdictional inclusion rules for individual jurisdictions, while not satisfying any exclusion rules for the jurisdictions in which they satisfied the jurisdictional inclusion rules, to jurisdictional account buckets organized in non-transient storage, and (ii) identify in scope/reason buckets in non-transient storage, on an individual account basis, all rules that caused the individual accounts to be assigned to particular jurisdictional account buckets or be excluded from the particular jurisdictional account buckets.

Yet another aspect involves a variant computerized account database access tool. The tool includes: a data extraction module configured to output account data retrieved for a database to non-transient data storage for use by rules modules; an inclusion rules module, coupled to the non-transient data storage, and configured to apply jurisdictional inclusion rules to the account data and store results of the application into non-transient inclusion results storage; an exclusion rules module, coupled to the non-transient data storage and the non-transient inclusion results storage, and configured to apply, on a jurisdictional basis, jurisdiction-specific exclusion rules to the stored results and store exclusion results in non-transient exclusion results storage; and a merge and aggregate module, coupled to the non-transient inclusion results storage and the non-transient exclusion results storage, configured to merge and aggregate contents of the inclusion results storage and the exclusion results storage and assign accounts to jurisdiction-specific account buckets based upon the merging and aggregation, and to identify, in scope/reason buckets for each account, rules that resulted in inclusion into or exclusion from any particular ones of the jurisdiction-specific account buckets.

The foregoing and following outlines rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 illustrates, in simplified form, a general functional overview of a risk minimizing computerized account database access tool as described herein;

FIG. 2 illustrates, in simplified form, the initial phase of the process performed by the tool;

FIG. 3 illustrates, in simplified form, the next phase in the process performed by the tool;

FIG. 4 illustrates, in simplified form, the next phase in the process performed by the tool;

FIG. 5 illustrates, in simplified form, the merger and aggregation phase of the process performed by the tool; and

FIG. 6 illustrates, in simplified form, the bucket assignment aspect of the approach performed by the tool.

### DETAILED DESCRIPTION

We have devised a technical solution to the query/report approach problem; a technical approach that helps ensure that accounts do not “fall through the cracks” or will be missed for review/re-review for compliance with policies implementing the CIP/AML/KYC rules and/or requirements to which an account may be subject in each jurisdiction, for example, rules implementing Section 526 of the U.S. Patriot Act, as well as other regulatory processes such as Hong Kong Professional Investors (HKPI), and the European Markets in Financial Instruments Directive (MiFID) 2004/39/EC.

Our technical solution is implemented as an automated approach that uses a form of “sifting” approach in which all accounts, irrespective of whether or not they are regulated or their pertinent jurisdictional associations, are extracted and conceptually sifted into one or more “buckets” such that each account will ultimately be in at least one such bucket and, since all accounts are processed, if any account does not make it into any jurisdictional bucket, it will be identified and can be reviewed for why that may be the case.

A general overview of our technical approach to solving the query/report problem will now be provided followed by a more detailed description of the components of the process and the process itself.

Every financial institution subject to CIP/AML/KYC requirements maintains records of its customer accounts in one or more databases (which may be implemented using a centralized and/or distributed architecture). Irrespective of the databases and how such databases are implemented, they generally contain the same kind of information for each “customer”, for example, the entity/part(y/ies) to the account, their location(s), the type of business, the type of account(s), the responsible representative and their location, the responsible office of the financial institution, the relationship between the part(y/ies) and the institution, and the role of the party, to name a few (collectively referred to herein as “client reference data”). Representative examples of databases for maintaining client reference data include the databases described in U.S. Pat. No. 7,685,060 and U.S. Pat. No. 7,966,253. Both these patents are incorporated herein by reference in their entirety as if fully set forth herein.

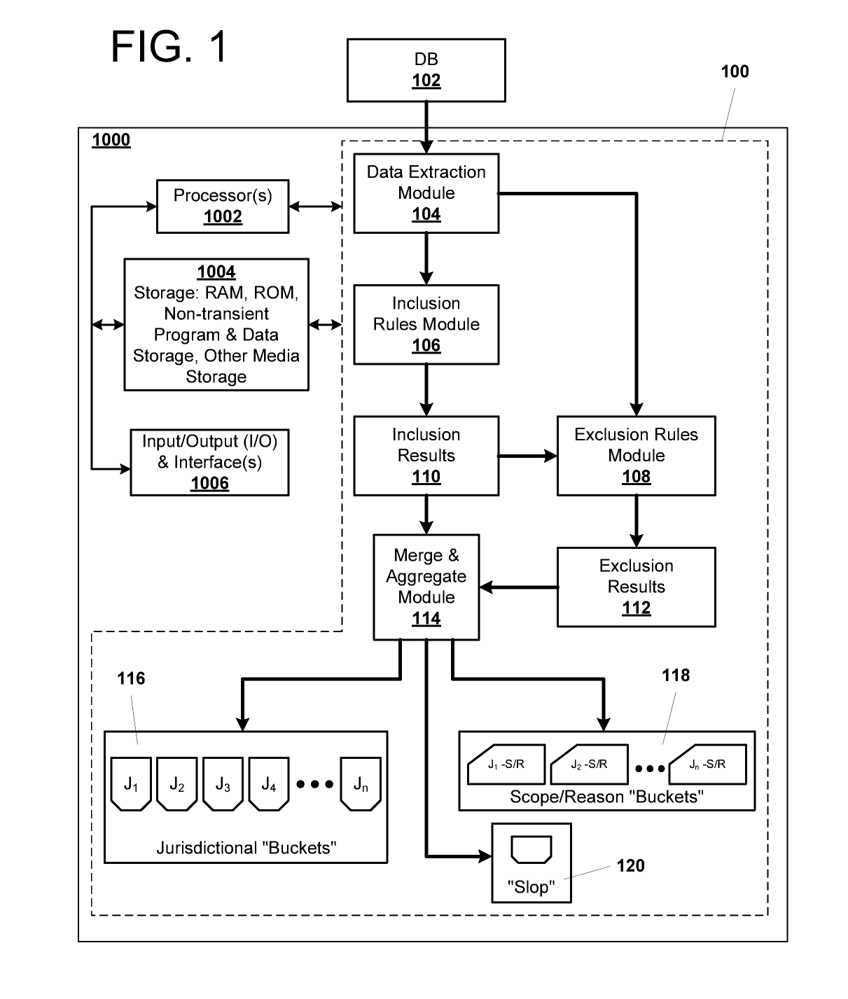

With the foregoing in mind, a functional overview of a tool and approaches for use in minimizing risk associated with complying with CIP/AML/KYC requirements by missing an account that should be certified will now be provided with reference to FIG. 1.

FIG. 1 illustrates, in simplified form, a general functional overview of a risk minimizing computerized account database access tool 100 as described herein. The tool 100 receives data from a database 102 that is a component part of an account management system (not shown) and contains data necessary to identify whether an account in the database is subject to CIP/AML/KYC certification requirements. For purposes of example and simplicity only, the database 102 of FIG. 1 should be understood to be configured, contain data, and operate, in the manner described in the incorporated by reference U.S. Pat. Nos. 7,685,060 and 7,966,253. Any other database, or databases, that contain the type of account information needed for this approach may also be used as the database 102 referenced herein.

The tool 100 is generally, from a functional standpoint, made up of a Data Extraction Module 104, an Inclusion Rules Module 106, an Exclusion Rules Module 108, Inclusion Rules Output Storage 110, Exclusion Rules Output Storage 112, a Merge & Aggregation Module 114, Jurisdictional Account Buckets 116, and “Scope/Reason” Buckets 118.

The Data Extraction Module 104 retrieves relevant account-related data for all accounts from the database 102 for further processing by the tool 100. The Inclusion Rules Module 106 analyzes the data for each account in accordance with a set of jurisdiction-specific inclusion rules that are constructed based upon the institutions “policies” (i.e. interpretation/implementation of the various CIP/AML/KYC requirements) and determines whether the account or any aspect of the account (e.g., role playing parties) is “out of scope” and, if not, it assigns that account and its role playing parties to one or more jurisdictional groupings within the Inclusion Rules Output Storage 110 based upon the results of the inclusion rules analysis. In other words, and as will be explained in greater detail below, an account could be assigned to two or more different jurisdictional groups because some aspect of the account makes it subject to the rules of more than one jurisdiction. If an account is “out of scope” for all jurisdictions then no further processing or analysis for that account is required. The Exclusion Rules Module 108 applies jurisdiction-specific exclusion rules (also constructed according to the institutions “policies”) to each of the jurisdictional groupings within the Inclusion Rules Output Storage 110 based upon their contents and the relevant account-related data from the database 102. In other words, if there are three jurisdictional groupings, Japan, the UK and the US, the Japan exclusion rules will be applied to the accounts in the Japan jurisdictional group, the UK exclusion rules will be applied to the accounts in the UK jurisdictional group, and the US exclusion rules will be applied to the accounts in the US jurisdictional group. Once the exclusion rules have been applied, the results are stored in the Exclusion Rules Output Storage 112. The Merge & Aggregation Module 114 uses the results of the inclusion and exclusion rules application stored in the respective Output Storage 110, 112, to assign each account to one or more Jurisdictional Account Buckets 116 while also maintaining information in the jurisdiction-specific “Scope/Reason” Buckets 118 relating to the results of the inclusion and exclusion analysis performed for each account. If, for some reason, any account cannot be assigned to at least one of the Jurisdictional Account Buckets 116, it is assigned to a default “Slop Bucket” 120 and any associated results of the inclusion and exclusion analysis is likewise maintained in the “S cope/Reason” Buckets 118.

In addition, satisfaction of any of the rules, can be noted in the appropriate storage using any known method including tags, setting/clearing flags, storing the actual rule or some other form of surrogate for a rule.

Thus, in contrast to the conventional query approach, it should be appreciated from this simplified overview that since all accounts are sifted through the process and any account that cannot be assigned to at least one bucket will be flagged, no account can “fall through the cracks” or be overlooked. Moreover, as will be seen in greater detail from the explanation below, at the end of the process, each account will have all the associated rules that caused them to be included and/or excluded from any given “bucket” so, advantageously, if an account is erroneously assigned (or not assigned) to a particular bucket, it is easy to review those associated rules to determine why.

Then, depending upon the reason, the account data or policy interpretation as reflected in the particular rule(s) that caused the erroneous assignment(s) can be revisited and modified if necessary.

With the preceding overview in mind, more in-depth details of the tool 100 will now be discussed. For ease of explanation, the details will be provided as if the process is entirely sequential. However, as will be mentioned again below in greater detail, it is to be understood that the various phases and their constituent component operations need not occur sequentially, rather they could overlap (i.e. they could occur partially or entirely concurrently) within a phase or among phases.

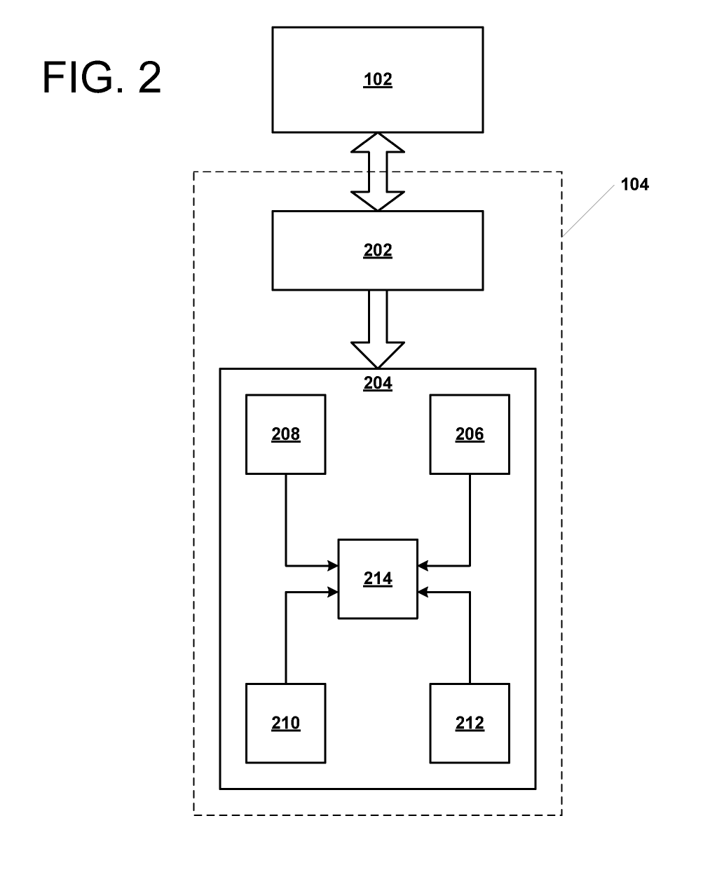

FIG. 2 illustrates, in simplified form, the initial phase of the process performed by the tool 100. The process begins with the Data Extraction Module 104 retrieving four classes of account-related information from the database 102. To do so, program code 202 associated with the Data Extraction Module 104 accesses the database 102 using a query and language appropriate to the particular database, for example, SQL (Structured Query Language), CQL (CODASYL Query Language), LINQ (Language Integrated Query), LDAP (Lightweight Directory Access Protocol), etc., to name a few, the important aspect being the ability to query and receive appropriate results, not the type of database or database query language needed to do so. The results are stored in appropriate storage 204 such that the interrelationship among the classes and data components are maintained.

The classes of information that the program code 202 retrieves (in any order or configuration) from the database 102, are: Party Information 206, Location information 208, Account Information 210, and Role Information 212.

The Party Information 206 can include, for example, a party's name, legal name, address, contact person, telephone number, FAX number, email address, legal form, marital status (if the party is an individual), jurisdiction of organization (if the party is a legal entity) and (optionally) a party relationship link establishing a relationship between parties (e.g., guarantor-guarantee, officer/director/partner, board member, parent/subsidiary, other related entit(y/ies)).

The Location Information 208 may partially overlap with the retrieved Party Information 206 because it can include, for example, the party's address, jurisdiction of organization (if the party is a legal entity), and it can also include, the address of the relevant trading office and/or office where the party's account is handled/resides, as well as, the address of the office where the account executive/agent/sales person/booking agent, etc. is located.

The Account Information 210 can include, for example, account number, account type (e.g., cash or margin), reference agreement that governs the client-financial institution relationship, parties that play a role in account (e.g., principal, order placer, booking company, salesperson, and a guarantor). Note that, in most cases, the retrieved Account Information 210 will not include account details related to transactional data unless, at least one of the rules pertaining to the CIP/AML/KYC requirements for at least one jurisdiction need it.

The Role Information 212 retrieved may also partially overlap with some Party Information 206 and/or Account Information 210 and may include, for example, the role(s) that each of the various entities associated with the account play, for example, guarantor, guarantee, officer, director, partner, board member, parent/subsidiary, agent, order placer, booking company, and/or salesperson.

The combination of the Party Information 206, Location Information 208, Account Information 210 and Role Information 212 and their interrelationships for each account collectively represent the Core Fact Data 214 that is used in later parts of the process.

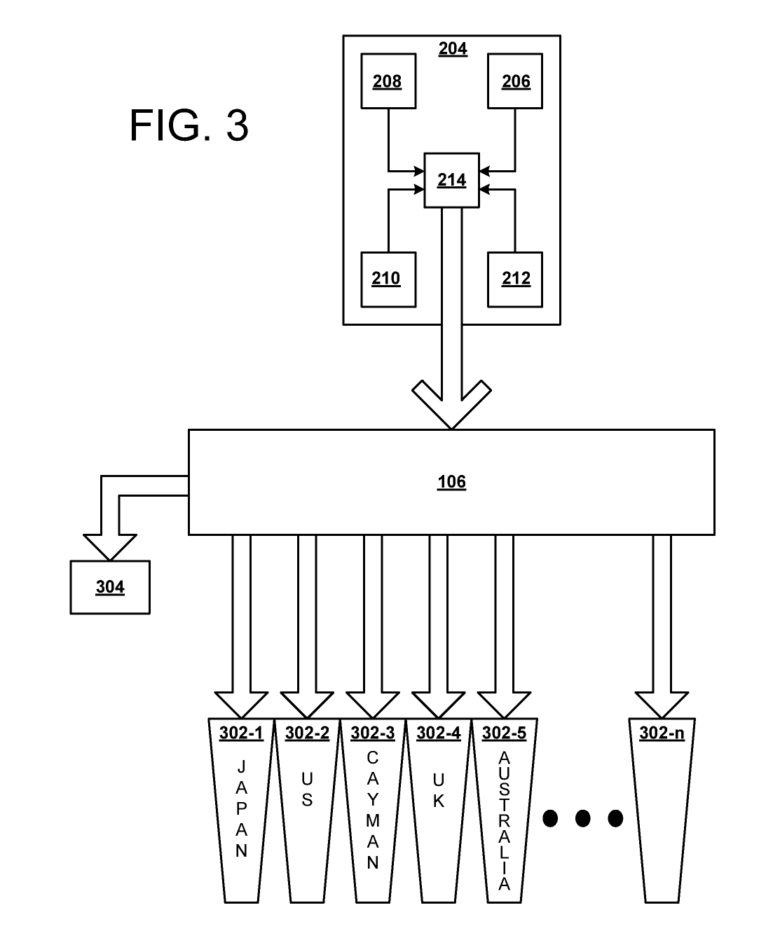

FIG. 3 illustrates, in simplified form, the next phase in the process performed by the tool 100. In this phase, accounts that are “out of scope” for all jurisdictions are removed/segregated and, as mentioned in connection with FIG. 1, the remaining the accounts are assigned to one or more virtual “jurisdictional groups” 302-1, 302-2, 302-3, 302-4, 302-5, . . . , 302-n (each being for a specific jurisdiction) according to a set of jurisdiction-specific inclusion rules. Of course, it should be understood that the number of virtual jurisdictional buckets can be expanded or contracted to coincide with the number of jurisdictions where accounts of the implementing entity may be subject to CIP/AML/KYC requirements.

Specifically, the Inclusion Rules Module 106 accesses the Core Fact Data 214 and initially checks the data for each account to determine whether any accounts are wholly “out of scope” for all jurisdictions and, if so, directly assign it to an “out of scope” bucket 304. Illustrative example reasons why an account may be “out of scope” for all jurisdictions could be, for example, that the account: (1) is an unregulated type of account because none of the Core Fact Data 214 for that account implicates any jurisdiction's CIP/AML/KYC requirements because all of the relevant party, location, account and role information wholly pertains to a jurisdiction that does not have any CIP/AML/KYC requirements, (2) is a purely internal account used for non-external purposes or for which no actual activity occurs, for example, an account used for program testing or user training purposes, or (3) has no role playing parties. Such “out of scope” accounts are not checked thereafter by the Inclusion Rules Module 106 using the jurisdiction inclusion rules or any other module.

The Inclusion Rules Module 106 likewise checks the Core Fact Data 214 for each account against the rules for each individual jurisdiction to determine whether it satisfies any of that jurisdiction's inclusion rules. If the account does satisfy at least one of that jurisdiction's inclusion rules, that account is assigned to the virtual jurisdictional group for that jurisdiction in the Inclusion Rules Output Storage 110, while the checks continue until all of the jurisdictional inclusion rules have been applied to that account for every jurisdiction, and, of course, similarly for all other relevant accounts. By way of illustrative example, some representative, illustrative rules that could result in inclusion in the US virtual jurisdictional group 302-2 could include whether the account: has a U.S. booking company, is a Rule 15a-6 account, etc. Thus, depending upon the particular Core Fact Data 214 for an account, the account can be assigned to one or more virtual jurisdictional groups. For example, an account for a U.S. company with a U.S. booking company, an order placer in Japan. and a Japan registered representative could result in that account being assigned to both the U.S. virtual jurisdictional group 302-2 and the Japan virtual jurisdictional group 302-1.

Once the Inclusion Rules Module 106 has completed the process for all accounts in the Core Fact Data 214 with respect to all jurisdictions for which there are inclusion rules, this phase of the process is compete.

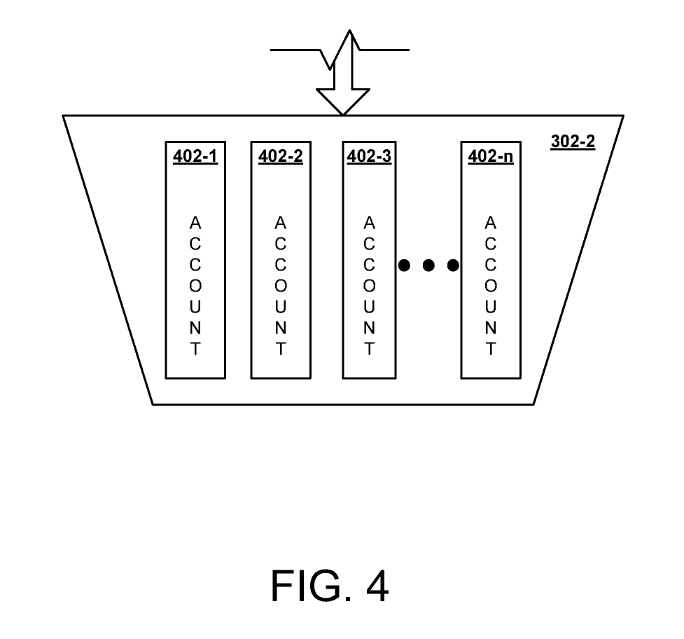

FIG. 4 illustrates, in simplified form, the next phase in the process performed by the tool 100. In this phase, Exclusion Rules Module 108 accesses each specific virtual jurisdictional group, for example the U.S. virtual jurisdictional group 302-2, and applies all the jurisdiction-specific rules (appropriate to that jurisdiction) that may exclude a particular account from that jurisdiction's CIP/AML/KYC requirements to each account 402-1, 402-2, 402-3, . . . , 402-n assigned to that group 302. Some reasons why an account may be excluded in this phase for the U.S. virtual jurisdictional group 302-2 of this example can include, for example: (1) the account is now inactive/closed, (2) the account is exempt based upon some grandfathering of the party or the account date, (3) the account is a non-customer account, etc. Other examples, for other jurisdictions could include, for example, that the account is a wholly domestic official government account, or any other appropriate reason(s) established by that jurisdiction.

Notably, if the Exclusion Rules Module 108 determines an account 402-1, 402-2, 402-3, . . . , 402-n satisfies some exclusion rule, it does not stop the analysis of that account. Rather, it notes the satisfaction for that account as an exclusion result and saves it in the Exclusion Rules Output Storage 112, but continues the analysis until all exclusion rules for that jurisdiction have been applied to that account.

Moreover, if an account 402-1, 402-2, 402-3, . . . , 402-n satisfies any of the exclusion rules for a virtual jurisdictional group 302, it is not removed from that virtual jurisdictional group 302. Rather, the specific applicable exclusion rule(s) it satisfied are all noted for that account 402-1, 402-2, 402-3, . . . , 402-n and saved in the Exclusion Rules Output Storage 112. In this way, once this phase is complete, for each account 402-1, 402-2, 402-3, . . . , 402-n in a virtual jurisdictional group 302 that satisfied any exclusion rule, it is possible to know every reason why that particular account may have been excluded from that jurisdiction's CIP/AML/KYC requirements.

Note here that, for simplicity, the inclusion and exclusion processes have been described as if they occur completely serially. While this may be the case in some implementations (and will be true for any specific account and group, because an account cannot undergo the exclusion phase for a particular group until it is assigned to that group), in other implementations, on an overall basis, as the Inclusion Rules Module 106 is including accounts in a virtual jurisdictional group 302, the Exclusion Rules Module 108 can begin the exclusion analysis for each account included in a group 302 i.e., without waiting for the inclusion process to complete. Thus, it should be appreciated that the inclusion and exclusion phases can, as a whole, overlap to varying degrees.

The next phase that follows is the merger and aggregation phase. In this phase, Merge & Aggregation Module 114 accesses and combines the contents of the Exclusion Results Storage 112 and the Inclusion Results Storage 110 for each account and jurisdiction in order to assign each account to one or more jurisdictional buckets.

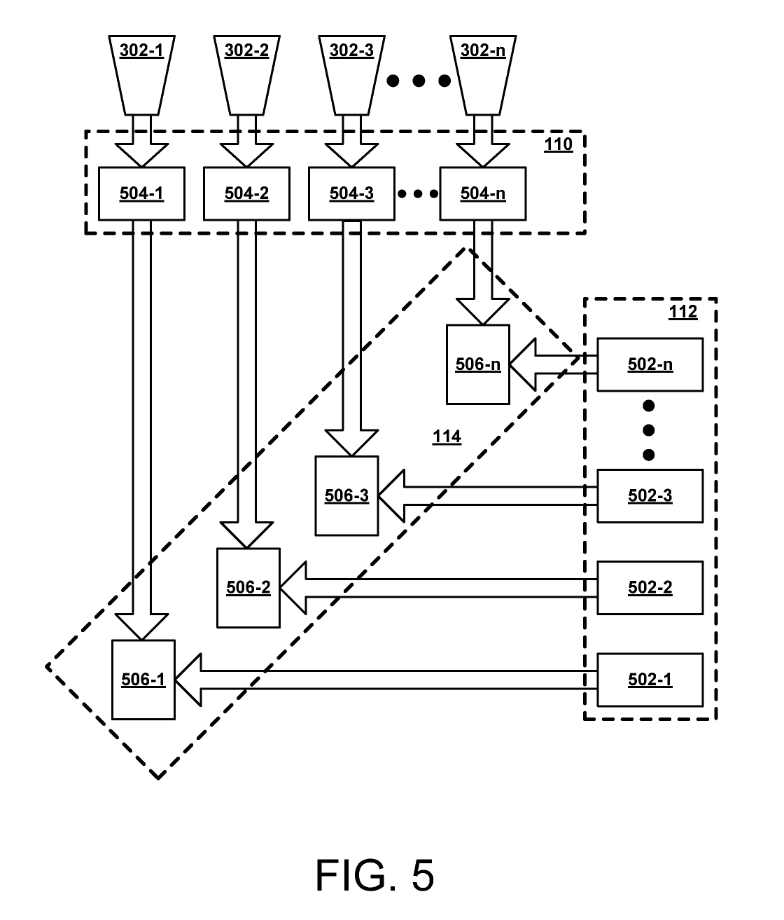

FIG. 5 illustrates, in simplified form, the merger and aggregation phase of the process performed by the tool 100. As shown in FIG. 5, the results 502-1, 502-2, 502-3, . . . , 502-n of the operation of the Exclusion Rules Module 108 is stored (directly, or indirectly using some surrogate form of indication) in the Exclusion Results Storage 112 and the group results 504-1, 504-2, 504-3, . . . , 504-n resulting from the Inclusion Rules Module 106 assigning the accounts (directly, or indirectly using some surrogate form of indication) to the appropriate virtual jurisdictional groups 302-1, 302-2, 302-3, . . . , 302-n is stored in the Inclusion Results Storage 110. The Merge & Aggregation Module 114 accesses this information stored in the Inclusion Results Storage 110 and Exclusion Results Storage 112 and combines that information for each account 506-1, 506-2, 502-6, . . . , 506-n on an account, relationship and jurisdictional basis.

As the merger and aggregation of the information for each account is completed, the accounts are assigned to one or more Jurisdictional Account Buckets 116, on a per jurisdiction and account basis, and the reason(s) for those assignments and any applicable account exclusions are stored in Scope/Reason” Buckets 118 on a per jurisdiction and account basis as well. Depending upon the particular implementation, as noted herein, the information in the Scope/Reason Buckets 118 can be maintained using the actual rules, tags, flags or some other indicators for each account and/or jurisdiction, as well as some combination thereof. In general, accounts that satisfied jurisdictional inclusion rules and have no exclusions for those jurisdictions will be subject to CIP/AML/KYC certification, whereas accounts that satisfied jurisdictional inclusion rules but have one or more exclusions will not.

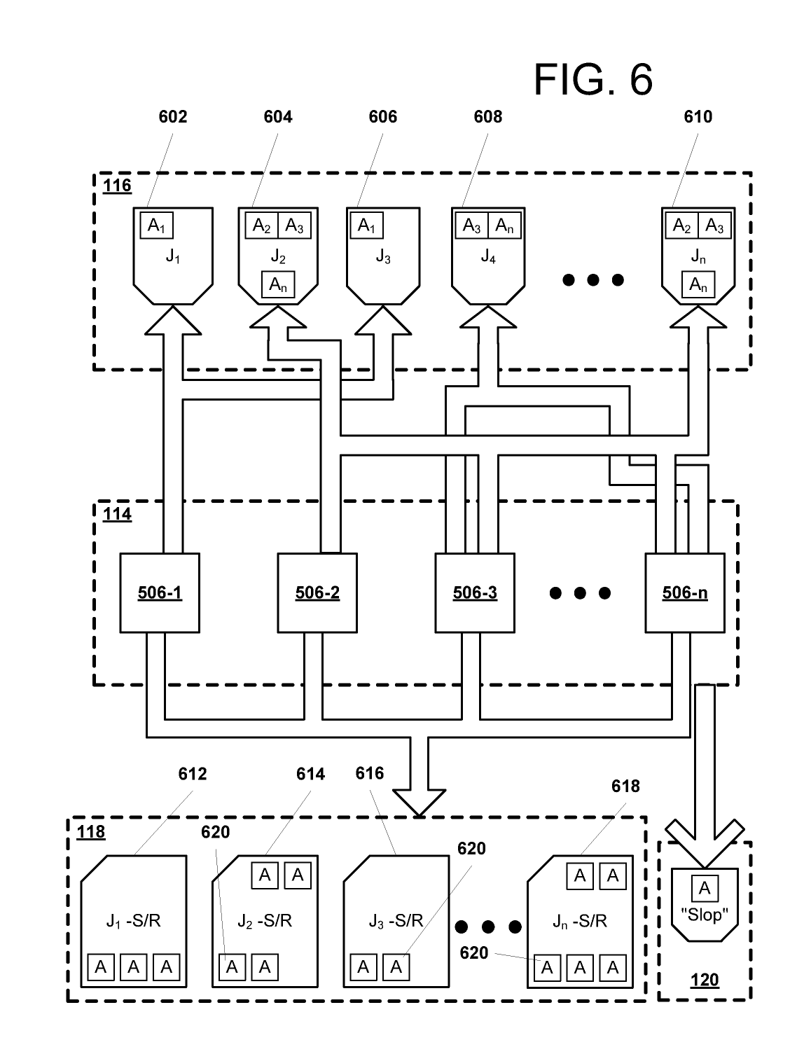

FIG. 6 illustrates, in simplified form, the bucket assignment aspect of the approach performed by the tool 100. As shown in FIG. 6, the combined account information 506-1, 506-2, 502-6, . . . , 506-n formed by the Merge & Aggregation Module 114 enables respective accounts to be assigned to their appropriate Jurisdictional Account Buckets 116, which, it should be understood, are areas of non-transient storage that can be accessed by a computer processor and their contents read, for example, for purposes of performing CIP/AML/KYC certification or generating reports.

Greater detail regarding the assignment of accounts to their specific buckets of the Jurisdictional Account Buckets 116 are shown by way of example in FIG. 6, a grouping 506-1 for one account “A₁” is assigned to both a Jurisdictional Account Bucket 602 for jurisdiction “J₁” and a Jurisdictional Account Bucket 606 for jurisdiction “J₃” because it satisfied one or more inclusion rules for both jurisdictions (and was not excluded by virtue of any jurisdiction-specific exclusion rules). Likewise, as a result of the rules analysis, another grouping 506-2 for another account “A₂” is assigned to both a Jurisdictional Account Bucket 604 for jurisdiction “J₂” and a Jurisdictional Account Bucket 610 for jurisdiction “Jₙ”. In similar fashion, a further grouping 506-3 for another account “A₃” and the final grouping 506-n shown for an account “Aₙ” are each assigned to three jurisdictional account buckets, the Jurisdictional Account Bucket 604 for jurisdiction “J₂” and a Jurisdictional Account Bucket 610 for jurisdiction “Jₙ ” as well as the Jurisdictional Account Bucket 608 for jurisdiction “J₄”. If any account “A_{X}” that made it past the initial “scope” screen (i.e. it was not wholly “out of scope” 304 for all jurisdictions), cannot be assigned to any jurisdictional (bucket because it did not satisfy any inclusion rules or was subsequently excluded from all jurisdiction groups by virtue of the exclusion rules) that account “A_{X}” is assigned to a “Slop” bucket 120 for further review.

In addition, for each account, a tag, flag, record or other identifier “A” 620 of the inclusion and exclusion rules that were satisfied is maintained in “Scope/Reason” Buckets 118, for each assigned account and jurisdiction 612, 614, 616, 618, as well as for any accounts assigned to the “Slop” bucket 120.

Advantageously, in this way, every account that is not wholly “out of scope” 304 for all jurisdictions will necessarily be assigned to at least one “bucket”, be it a “Jurisdictional Account Bucket” or the “Slop” bucket, so no account can “slip through the cracks” or be missed. This makes for easier compliance auditing and significantly reduces organizational non-compliance risk.

Moreover, this approach provides three further advantages not reliably found in current systems and approaches that rely upon search queries. First, it is possible to review any account and know exactly why that account was assigned to any particular jurisdictional bucket for purposes of CIP/AML/KYC certification and all reasons why it may have been excluded from a particular jurisdiction. This is a powerful advantage because it can highlight a discrepancy between the actual CIP/AML/KYC requirements and the interpretation that allows those requirements to be applied against accounts and readily fix any rules that result in under-inclusive or over-inclusive handling of any account(s). Second, it is readily extensible and alterable such that, if new jurisdiction(s) are added, simple modification of the Inclusion Rules Module 106 and Exclusion Rules Module 108 can be made to accommodate the new jurisdiction(s). Likewise, if a rule (or interpretation implementing any rule) changes for an existing jurisdiction for which there is already a Jurisdictional Account Bucket, that change can be accommodated by a simple change to the Inclusion Rules Module 106 and/or Exclusion Rules Module 108 as required. This is also a powerful advantage because it reduces the time necessary to implement any rules change, thereby helping to ensure compliance re-certification needed as a result of such rule(s) change(s) can be handled quickly. Third, with this approach, if any information that would be retrieved for an account by the Data Extraction Module 104 changes (referred to herein as an account “delta”), that account can easily (and in some implementations automatically) be re-processed without the need to do so for any other account. This advantage is extremely useful, because it helps to ensure proactive compliance. This advantage is readily achievable if the Database 102 includes some form of update or change flag or other indication which the Data Extraction Module 104 can use to identify any accounts for which relevant changes have occurred. Of course, such flag or indication can similarly be used to identify a newly added account (i.e., one that was added since the last run of the instant system). It should be understood however, that these are not the only ways that a new account or account delta can be noted. Indeed, there are many known techniques that can be implemented to identify an account as being new or having a delta, so it should be understood that any of those approaches (or any other approach) that can accomplish this can be used.

At this point it is worth noting that, once the process has been run for all accounts, thereafter, it need only be run for new accounts or accounts for which there is an account delta. Depending upon the particular implementation and implementing entity needs, checks for either circumstance can be periodically run, for example, every 12 hours, daily, weekly, etc., and/or on an as-needed basis.

This is in sharp contrast to the report/query approach, particularly for account deltas, which still relies upon the specific query being formulated to catch the particular delta.

Having described the system and approach above, for further purposes of understanding, some simple examples of different circumstances will now be provided.

For the first example, presume that there is a specific account in the database 102 in which a party identified in the account data has a role on an account where the account is aligned to a regulated booking company for the U.S. As a result, the Inclusion Rules Module 106 groups it to the U.S. jurisdiction. Moreover, presume that the analysis by the Exclusion Rules Module 108 for the U.S. exclusions results in no exclusions. As a result, after merger and aggregation, that account is assigned to the U.S. Jurisdictional Account Bucket for CIP/AML/KYC certification and the Scope/Reason Bucket 118 for the U.S. jurisdiction is updated to reflect that account's inclusion because the “U.S. regulated booking company” rule was satisfied. Thus, the indications for this account in this example could be:
Jurisdiction(s): “US”
Satisfied Inclusionary Rule(s): “Booking Company—US”
Exclusionary Rule(s): “None”
Out of Scope: “No”
Slop Bucket: “No”

For the second example, presume that there is another specific account in the database 102 in which the account is US based, but the booking company is confirmed as unregulated and there is no other basis for inclusion. Since the booking company is unregulated, the Inclusion Rules Module 106 would assign that account to the unregulated or “out of scope” bucket 304 and therefore, that account would not become part of the population for CIP/AML/KYC certification. Thus, the indications for this account in this example could be:
Jurisdiction(s): “N/A”
Inclusionary Rule(s): “None”
Exclusionary Rule(s): “None”
Out of Scope: “Yes”
Slop Bucket: “No”

The third example is similar to the second example in that the account data is identical except that there is no indication as to whether the booking company on the account is regulated or not regulated for some reason. As a result, the account is not “out of scope” because the booking company on the account may be regulated for one or more jurisdictions. As a result, the Inclusion Rules Module 106 cannot assign it to any jurisdiction and, consequently, the Exclusion Rules Module 108 cannot apply any jurisdictional exclusion rules because the account is not assigned to a jurisdictional group. As a result, the account gets assigned to the “Slop” bucket 120 so that it can be reviewed and the information reflecting whether the booking company is regulated or not regulated can be updated and CIP/AML/KYC certification can be performed for the relevant jurisdiction(s). Depending upon the particular implementation, this update can result in the process being re-run for this account, or it can be manually assigned to the appropriate particular jurisdiction(s) in the first instance and only included in the process thereafter in the manner of any other account that was successfully handled to the end (i.e., included in one or more Jurisdictional Account Buckets 116 and Scope/Reason Buckets 118) by the process.
Jurisdiction(s): “N/A”
Inclusionary Rule(s): “None”
Exclusionary Rule(s): “None”
Out of Scope: “No”
Slop Bucket: “Yes”

The fourth example is a bit more complex. For this example, presume an account is aligned to a regulated UK booking company and a sales representative on the account is located in Japan. As a result, the account is included by the Inclusion Rules Module 106 in the UK group 302-4 of FIG. 3 because it satisfied the inclusion rule of “Aligned to a regulated UK booking company”. In addition, the account is included by the Inclusion Rules Module 106 in the Japan group 302-1 because it satisfied the “Sales representative location” inclusion rule since the sales representative for the account is located in Japan. That account would then be analyzed by the Exclusion Rules Module 108 according to the exclusion rules for both the UK and Japan because it is assigned to both groups. Presuming that the account does not satisfy any Japan-specific exclusion rules, after merger and aggregation, the account would be assigned to the Jurisdictional Account Bucket 116 for Japan and the reason(s) for its inclusion in the Japan bucket would be noted in the Scope/Reason Bucket 118 for Japan. Presume further that the account is, for UK purposes, a “Rule 15a-6” account and a “limited purpose” account. As such, the application of the UK-specific exclusion rules by the Exclusion Rules Module 108 would result in the account being excluded from the Jurisdictional Account Bucket 116 for the UK because it satisfied the UK-specific exclusion rule of “Rule 15a-6” account and, independently, because it satisfied the UK-specific exclusion rule of “limited purpose” account too. As a result, while that account would not be included in the Jurisdictional Account Bucket 116 for the UK, the Scope/Reason Bucket 118 for the UK would be updated with that account and the specific reasons why it was excluded from the Jurisdictional Account Bucket 116 for the UK. Thus, if it turned out that there was an error and the account was actually not a “Rule 15a-6” account, that error could easily be identified and rectified. If the “limited purpose” characterization did not change following the correction, the account would still be excluded from the Jurisdictional Account Bucket 116 for the UK, because of the satisfaction of the “limited purpose” business definition rule. Likewise, if the account was actually not a “limited purpose” account but was properly a “Rule 15a-6” account, it would likewise still be excluded from the Jurisdictional Account Bucket 116 for the UK because it still satisfies the “15a-6” account exclusion rule. Of course, if all of the information remained unchanged and the account was reactivated for the UK and became, for example, an external trading account, then the account would be included in the Jurisdictional Account Bucket 116 for the UK, and the Scope/Reason Bucket 118 for the UK would be updated to reflect each basis for inclusion in the Jurisdictional Account Bucket 116 for the UK and the lack of any UK exclusions.
Jurisdiction(s): “UK” “Japan”
Inclusionary Rule(s): “Booking Company—UK” “Sales RR—Japan”
UK Exclusionary Rule(s): “Rule 15a-6” “Limited Purpose Account”
Japan Exclusionary Rule(s): “None”
Out of Scope: “No”
Slop Bucket: “No”

Once an account has been suitably classified, automatic triggering of appropriate CIP/AML/KYC certification review for the assigned jurisdiction(s) by the relevant personnel will occur, and the relevant Scope/Reason information for each account will be accessible such that, each reason for a classification error can be identified and any account in a “Slop” bucket can be reviewed with regard to why it could not be classified to at least one jurisdiction bucket. Where an error is found, depending upon the cause of the misclassification (e.g. rules and/or database data), the inclusion rule(s), exclusion rule(s) and/or database data will be updated such that the misclassification error will not recur. Thus, the technical problem of missing an account cannot occur because, with the instant solution, all accounts will be assigned to at least one “bucket” even if the bucket is the “Slop” bucket.

Physical Implementation

As a final matter, returning back to FIG. 1, it is to be noted that the tool described herein and its approaches are implemented in and using one or more computers 1000, which may be any type of computer including a mainframe, one or more serves, personal computers, etc. capable of performing the tasks described herein. As is well known, such computers all typically include one or more processors 1002, storage 1004 in the form of random access memory (RAM), read-only memory (ROM), non-transient program storage, other non-transient storage such as disks, tape, DVD, CD, or any other media, input/output (I/O) 1006 ports and/or devices, and may further include input devices like a keyboard, mouse, digitizing tablet, touch screen interface, display/output devices such as one or more screens, a printer, as well as communication capability in the form of one or more wired and/or wireless network interfaces. It is to be understood that the term “computer” as used herein is intended to encompass all computer architectures, configurations and associated auxiliary devices as would be understood to be used in implementing the tool and approaches described herein. Likewise, reference to “a processor” is intended to encompass one, or more than one, processing element(s) whether microprocessor(s), minicomputer or mainframe processing units, server(s), or any other type of processing element, known or subsequently developed.

It is also to be understood that the tool and approaches described herein can be implemented in software, firmware, hardware or (most likely) some permutation/combination thereof. Since it is well known that, from a design and operational standpoint, software and hardware almost always interchangeable, it is to be understood that references herein to “software,” “program,” “programming” or “module” are to understood as referring to any implementation, whether entirely in hardware, entirely in software and/or firmware running on some hardware (i.e., executed by one or more processors), or some combination thereof.

Additional Variants

Depending upon the particular implementation, the analysis and bucketing of the accounts need not involve direct manipulation of the account information retrieved from the database. Instead, in some implementations, the inclusion and exclusion analysis can merely involve examining that retrieved account information and setting (in specific non-transient storage) pre-specified flags for each account that corresponding to the specific jurisdictions and the inclusion and/or exclusion rules, or the assigning of “tags” to each account or account identifier where each tag represents satisfaction of a jurisdiction-specific inclusion or exclusion rule. In such variants, the results (i.e., the flags and/or tags) could be maintained for each account in non-transient storage (e.g., inclusion results storage, exclusion results storage and/or Scope/Reason Buckets) as described above, instead of maintaining the actual rule or its surrogate in the storage.

In some implementations, where the tool is used on a periodic basis of some sort (regularly or irregularly), the contents of the Jurisdictional Account Buckets 116 and the Scope/Reason Buckets 118 can be sequentially retained according to known methods such that a history of the jurisdictional inclusion/exclusion for each account can be searched, retrieved or viewed.

In further implementations, the flags, tags and/or bucket contents can be searchable according to any information available, e.g., the retrieved account data and contents of the Jurisdictional Account Buckets 116 and the Scope/Reason Buckets 118. In this manner, queries can be performed in a manner that ensures complete capture. For example, the tool could be queried to provide a report of all accounts that satisfied a particular rule (inclusion or exclusion), without regard to satisfaction or not of any other rule or information. Or the tool could be queried to provide a report of all accounts in the Japan bucket, or that were specifically excluded from the Japan bucket by virtue of satisfying a Japan-specific exclusion rule. Or the tool could be queried to provide a report of all accounts where the sales office is Australia along with all rules (inclusion or exclusion) that all such accounts satisfied.

Having described and illustrated the principles of this application by reference to one or more example embodiments, it should be apparent that the embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A computerized method of identifying accounts stored in a database of a computerized account management system, for review under jurisdictionally relevant CIP/AML/KYC requirements, the method comprising:
retrieving, using a processor, specified data from all accounts in the database of the computerized account management system;
for each account, using the retrieved specified data and the processor, determining whether each account is to be evaluated against regulatory requirements for at least one jurisdiction, out of multiple jurisdictions, by comparing retrieved data for each account with each of multiple jurisdiction-specific inclusion rules and, in each instance where an individual account satisfies a jurisdiction-specific inclusion rule, storing an identifier of that individual account in inclusion results storage specific to the jurisdiction associated with the satisfied jurisdiction-specific inclusion rule;
applying exclusion rules associated with a specific jurisdiction to the retrieved data for each individual account whose identifier is stored in the inclusion storage for the specific jurisdiction and, in each instance where the retrieved data for the individual account satisfies one or more of the specific jurisdiction exclusion rules, storing that individual account's identifier in exclusion results storage along with exclusion data reflecting the one or more satisfied jurisdiction-specific exclusion rules; and
merging and aggregating all of the accounts, using contents of the inclusion results storage and exclusion data from the exclusion results storage, to (i) assign the accounts to per-jurisdiction buckets for review under the relevant CIP/AML/KYC requirements of the respective jurisdictions; and (ii) maintain Scope/Reason buckets reflecting, for each account, each inclusion rule that caused them to have specific jurisdictional associations and each exclusion rule that caused any of the accounts to be excluded from review under any jurisdiction's CIP/AML/KYC requirements, such that, after the merging and aggregating, all accounts will be analyzed and assigned to one or more of the per jurisdiction buckets or at least one default bucket and none of the accounts will go unassigned.

2. The computerized method of claim 1, wherein the retrieving the specified data comprises:
retrieving one or more of (a) account information, (b) party information, (c) location information, or (d) role information.

3. The computerized method of claim 2, wherein the party information includes one or more of:
a party's name, a legal name, an address, a contact person, a telephone number, a FAX number, an email address, a legal form, a marital status, a jurisdiction of organization, or a party relationship link.

4. The computerized method of claim 2, wherein the location information includes one or more of:
an address of a party, a jurisdiction of organization, a address of a trading office, an office where the party's account is handled or resides, or an address of an office where an account executive or agent or sales person or booking agent for the account is located.

5. The computerized method of claim 2, wherein the account information includes one or more of:
an account number, an account type, a reference agreement that governs the client-financial institution relationship, an identification of a principal, order placer, booking company, salesperson, or a guarantor for the account.

6. The computerized method of claim 2, wherein the role information includes one or more of:
a guarantor, a guarantee, an officer, a director, a partner, a board member, a parent/subsidiary, an agent, an order placer, a booking company, or a salesperson, of or for a party to the account.

7. The computerized method of claim 1, wherein the storing the identifier comprises:
storing a tag in the inclusion results storage.

8. The computerized method of claim 1, wherein the storing the identifier comprises:
setting a flag in the inclusion results storage.

9. The computerized method of claim 1, wherein the storing the exclusion data comprises at least one of:
storing a rule in the exclusion results storage, storing a tag in the exclusion results storage, or setting a flag in the exclusion results storage.

10. A computerized account database access tool comprising:
a data extraction module, running on at least one processor associated with the tool, configured to receive specified data from all accounts in a database of a computerized account management system and store the received specified data in non-transient storage;
an inclusion rules module, running on the at least one processor, configured to analyze the stored specified data in accordance with jurisdictional inclusion rules and assign accounts that satisfy at least one inclusion rule for a jurisdiction to inclusion results storage in a group for that jurisdiction;
an exclusion rules module, running on the at least one processor, configured to analyze, on a jurisdiction basis, the accounts assigned to jurisdictional groups in the inclusion results storage and store analysis results in exclusion results storage; and
a merge and aggregate module, running on the at least one processor, configured to merge and aggregate the accounts stored in the inclusion results storage with the analysis results in the exclusion results storage in order to (i) assign accounts that satisfy jurisdictional inclusion rules for individual jurisdictions, while not satisfying any exclusion rules for the jurisdictions in which they satisfied the jurisdictional inclusion rules, to jurisdictional account buckets organized in non-transient storage, and (ii) identify in scope/reason buckets in non-transient storage, on an individual account basis, all rules that caused the individual accounts to be assigned to particular jurisdictional account buckets or be excluded from the particular jurisdictional account buckets, such that, when the merge and aggregate module has completed merging and aggregating all accounts, each account will be assigned to one or more of the jurisdictional account buckets or at least one default bucket, and none of the accounts will go unassigned.

11. The computerized account database access tool of claim 10, wherein the at least one default bucket comprises:
a Slop bucket, in non-transient storage and accessible to the merge and aggregate module, to which a specific account that satisfies no inclusion rules for any jurisdiction will be assigned.

12. The computerized account database access tool of claim 10, wherein at least one of the inclusion results storage, exclusion results storage or scope/reason buckets in non-transient storage include rule-identifying indicators.

13. The computerized account database access tool of claim 12, wherein the rule-identifying indicators comprise one or more tags.

14. The computerized account database access tool of claim 12, wherein the rule-identifying indicators comprise one or more flags.

15. A computerized account database access tool comprising:
a data extraction module configured to output account data retrieved for a database to non-transient data storage for use by rules modules;
an inclusion rules module, coupled to the non-transient data storage, and configured to apply jurisdictional inclusion rules to the account data and store results of the application into non-transient inclusion results storage;
an exclusion rules module, coupled to the non-transient data storage and the non-transient inclusion results storage, and configured to apply, on a jurisdictional basis, jurisdiction-specific exclusion rules to the stored results and store exclusion results in non-transient exclusion results storage; and
a merge and aggregate module, coupled to the non-transient inclusion results storage and the non-transient exclusion results storage, configured to merge and aggregate contents of the inclusion results storage and the exclusion results storage and assign accounts to jurisdiction-specific account buckets based upon the merging and aggregation, and to identify, in scope/reason buckets for each account, an identification of rules that resulted in inclusion into or exclusion from any particular ones of the jurisdiction-specific account buckets.

16. The computerized account database access tool of claim 15, further comprising a Slop bucket in non-transient storage and accessible by the merge and aggregate module.

17. The computerized account database access tool of claim 15, wherein the identification is maintained in non-transient inclusion results storage and comprises:
rule-specific tags.

18. The computerized account database access tool of claim 15, wherein the identification is maintained in non-transient exclusion results storage and comprises:
rule-specific tags.

19. The computerized account database access tool of claim 15, wherein the scope/reason buckets for each account comprise at least one of:
rule-specific tags or rule specific flags.

20. The computerized account database access tool of claim 15, wherein the tool is configured to automatically trigger a review of scope information stored in non-transient storage for an account when the account is assigned to a Slop bucket.
